(19) United States
(12) Patent Application Publication
(10) Pub. No.: US 2026/0208435 A1
(43) Pub. Date: Jul. 23, 2026

(54) 3D PRINTING OF STRETCHABLE AND COMPRESSIBLE FOAMS

(71) Applicant: Yissum Research Development Company of the Hebrew University of Jerusalem Ltd., Jerusalem (IL)

(72) Inventors: Shlomo MAGDASSI, Jerusalem (IL); Ouriel BLIAH, Tekoa (IL)

(73) Assignee: Yissum Research Development Company of the Hebrew University of Jerusalem Ltd., Jerusalem (IL)

(21) Appl. No.: 19/142,504

(22) PCT Filed: Jan. 17, 2024
(86) PCT No.: PCT/IL2024/050067

§ 371 Date: Jun. 23, 2025

Related U.S. Application Data
(60) Provisional application No. 63/480,380, filed on Jan. 18, 2023.

(51) Int. Cl. B29C 64/129; B29C 64/30; B29C 71/02; B29K 33/04; B29K 75/00; B29K 105/00; B29L 31/60; B33Y 10/00; B33Y 40/20; B33Y 80/00

(52) U.S. Cl. CPC B29C 64/129; B29C 64/30; B29C 71/02; B33Y 10/00; B33Y 40/20; B33Y 80/00; B29K 2033/04; B29K 2075/00; B29K 2105/0085; B29L 2031/608

(57) ABSTRACT

The invention includes 3D printed foams and porous objects having a multiscale porosity.

This project has received funding from the European Union's Horizon 2020 Research and Innovation Programme under Grant Agreement No. 863212

### TECHNOLOGICAL FIELD

The invention generally contemplates 3D printable foam materials with unique mechanical properties.

### BACKGROUND

Polymeric foams are materials that may be regarded as biphasic materials, wherein the first phase is a polymer matrix, and the other is constituted of dispersed gas voids, which can be separate or connected. Polymeric foams have been utilized in a variety of applications due to their extraordinary properties, which include, for example, low density, tunability of mechanical properties, sound and heat insulation, and good energy absorption. The excellent insulating and energy absorption properties are due to the cellular structure of the polymeric foams, which can disperse the impact energy throughout the structure by deformation of the cells. Therefore, the foam can endure forces and large impacts that equivalent non-porous polymers cannot. The conventional methods for fabricating such polymers are few and include mold casting using sacrificial powder or by intrinsic chemical reactions that cause the emission of gases, thereby limiting the design to simple geometries only.

While three-dimensional printing (3DP) has been generally employed for fabricating polymeric foams [1-5], diverse foams with high structural complexity, high resolution and diverse mechanical properties could not be produced. As the art shows, foams produced by 3D printing demonstrated stiffness and a resulting brittleness which limited their applications.

### REFERENCES

[1] I. Cooperstein, M. Layani, S. Magdassi, 3D printing of porous structures by UV-curable O/W emulsion for fabrication of conductive objects, J Mater Chem C Mater. 3 (2015) 2040-2044.
[2] M. Sus̆ec, S. C. Ligon, J. Stampfl, R. Liska, P. Krajnc, Hierarchically porous materials from layer-by-layer photopolymerization of high internal phase emulsions, Macromol Rapid Commun. 34(2013 ) 938-943.
[3] J. Guo, Y. Zeng, P. Li, J. Chen, Fine lattice structural titanium dioxide ceramic produced by DLP 3D printing, Ceram Int. 45(2019 ) 23007-23012.

[4] G. Qi, Y. Zeng, J. Chen, Preparation of porous SnO2-based ceramics with lattice structure by DLP, Ceram Int. 48(2022 ) 14568-14577.

[5] Y. Fu, Z. Chen, G. Xu, Y. Wei, C. Lao, Preparation and stereolithography 3D printing of ultralight and ultrastrong ZrOC porous ceramics, J Alloys Compd. 789(2019 ) 867-873.

### GENERAL DESCRIPTION

The inventors of the technology disclosed herein have now developed a digital 3D printing methodology which demonstrated effectiveness in manufacturing 3D polymeric foams that are uniquely stretchable, compressible, and generally flexible. The polymeric foams are obtained from a water-in-oil (W/O) emulsion in which water droplets are the pore-forming material, and the continuous phase is formed of a stretchable photocurable polymer or an elastomer. These emulsions are 3D printed by a digital printing methodology that utilizes a photopolymerization process, such as Digital Light Processing (DLP) technology, or by any printing methodology, resulting in porous stretchable soft complex structures.

As demonstrated herein, the printed objects are uniquely characterized as a matrix structure that includes interconnected cells, and which the structure overall cellular design and geometry may be predetermined and achieved by a light-based printing technology, e.g., 3DP technology. Walls of the cells are further provided with a random distribution of various pockets or pores or voids that improve the mechanical properties of the polymeric object.

In its broadest aspect, the invention provides a process for manufacturing a polymeric foam or a porous organic material having a pore hierarchy, whereby nanopores and micropores (e.g., ranging in size between 5 nm and 50 μm) are located in interconnecting walls of larger pores or cells that may be in the micrometer scale, or even in the millimetric/centimetric scale. While the larger pores or cells are achievable by predesign, employing 3D printing methodologies, the small scale nanometric or micrometric pore structures are achievable by utilizing a water-in-oil (W/O) ink emulsion or resin.

Putting it differently, the invention provides a 3D printed polymeric foam (or a foam material) or a polymeric porous object characterized by a multiscale porosity having pores ranging from a few nanometers to several centimeters, wherein the multiscale porosity comprises predesigned macrometric cells connected by porous walls, wherein the porous walls having a random micrometric pore structure. Alternatively, the 3D printed polymeric foam or polymeric porous object may be defined as having a multiscale porosity comprising predesigned macrometric cells connected by porous walls, wherein the porous walls having a random micrometric pore structure, and wherein the macrometric cells and micrometric pore structures having a size ranging between 5 nm and 2 cm.

In an aspect of the invention there is thus provided a 3D printed polymeric foam having a multiscale porosity comprising predesigned macrometric cells connected by porous walls having a random micrometric pore structure, and wherein the macrometric cells and micrometric pore structure having a size ranging from 5 nm to 2 cm.

In some embodiments, the foam is a stretchable or flexible foam.

As used herein, the term “multiscale porosity” means a porosity characterized by pores of different dimensions, that is pores of sizes ranging from the nanometric range to the macrometric (mm or cm) range. The multiscale porosity characteristics of foams and objects of the invention includes macrometric cells and micrometric pore structures. The term “cell” or “cell structure” generally encompasses a cavity or an opening in the foam structure that is unlimited in shape and size. Each cell is defined by side walls that separate neighboring cells and act as interconnecting walls or struts. The cells are typically open structures with dimensions in the micrometric, millimetric or centimetric range. Unlike the cells, the term “pore” refers to an open or a closed cavity of much smaller dimensions, which are provided mainly or only in the walls that separate neighboring cells (the so-called interconnecting walls). The pores are typically of dimensions much smaller than the cells dimensions. The pores dimensions may be in the nanometric or micrometric size range.

In some embodiments, the multiscale porosity having pores ranging from 5 nm to 50 μm.

In some embodiments, the macrometric cells comprise a plurality of interconnected cells having a size (or sizes) ranging between 2 mm and 50 mm, and wherein the cells having walls with micrometric pore (or pore structures) comprising a plurality of pores having a size (or sizes) ranging between 5 nm and 50 μm.

In some embodiments, the micrometric pore structures comprising a plurality of pores having a size ranging between 50 nm and 10 μm. In some embodiments, the micrometric pore structure comprising a plurality of pores having a size ranging between 1 and 10 μm. In some embodiments, the micrometric pore structure comprising a plurality of pores having an average size of about 3 μm.

The invention further provides a stretchable polymeric or organic foam or a stretchable porous object with a pore hierarchy design characterized by micrometric pores (defined by nanopores and/or micropores ranging in size between 5 nm and 50 μm) present in interconnecting walls of macrometric cells (larger pores or cells that may be in the micrometer scale, or even in the millimetric/centimetric scale), wherein the walls of the macrometric cells are formed by 3-dimentional printing and wherein the micrometric pores are formed by photocuring of a water-in-oil emulsion comprising a light-curable organic material.

In some embodiments, the object or foam is stretchable to at least 100% of its original unstretched length (or stretched along any other axis of the object or foam). In other words, the object or foam has a stretched form or state with at least one dimension that is at least 100% of the same at least one dimension measured for its unstretched state. In some embodiments, the object or foam has a stretched state with at least one dimension that is at least 200, 300, 400 or 500% of the same at least one dimension measured for its unstretched state. The dimension along which the stretchability is measured may be its length or its longest axis.

In some embodiments, following stretching to any extent or to any degree, the object or foam rapidly or immediately recovers its original dimensions.

Also provided is a 3D printed foam comprising or consisting or consisting essentially polyurethane acrylate, the foam having a multiscale porosity comprising predesigned macrometric cells connected by porous walls having a random micrometric pore structure, and wherein the macrometric cells and micrometric pore structure having a size ranging from 5 nm to 2 cm.

Further provided is a 3D printed foam comprising or consisting or consisting essentially polyurethane acrylate, the foam having a multiscale porosity comprising predesigned macrometric cells connected by porous walls having a random micrometric pore structure, wherein the macrometric cells having a size ranging between 2 mm and 50 mm and wherein the micrometric pore structure comprising a plurality of pores having a size ranging between 5 nm and 50 μm.

As used herein, according to some non-limiting embodiments, the 3D printed foam may comprise, consist or consist essentially of a single or combination of polymeric materials. In some cases, the 3D printed foam comprises, consists or consists essentially polyurethane acrylate. The term “consists essentially” means that the foam contains the indicated polymer, and may contain additional materials provided that the additional materials are present in much smaller amounts or concentrations, or provided that the additional materials are additives, or provided that the additional materials are present are not polymeric, or provided that the additional materials are impurities or in ppm amounts or in amounts not greater than 5wt %.

In some embodiments, the 3D printed foam may be formed solely of polyurethane acrylate or may be formed of polyurethane acrylate as the main polymeric material, and may contain other additives as disclosed herein.

In some embodiments, the foam may be manufactured by light curing of a water-in-oil resin comprising at least one light-curable material.

In some embodiments, the at least one light curable material is as disclosed herein, being in some specific embodiments urethane acrylate.

In some embodiments, the foam according is manufactured as disclosed herein. Generally, process of the invention comprises 3D printing by light curing of a water-in-oil resin comprising at least one light-curable material.

The invention provides a process for forming a foam material, the process comprising light-curing a resin in a form of a water-in-oil emulsion comprising at least one light-curable material (e.g., a monomer, oligomer polymer or prepolymer) and at least one photoinitiator, to obtain a predesigned 3D porous structure comprising interconnected cells, wherein walls interconnecting the cells comprise micrometric pores (open or closed) having random sizes and pore distribution.

In some embodiments, at least a portion or all of the micrometric pores are formed as water or liquid droplets or pockets (containing water or an aqueous medium) that are volatile, thus enabling evaporation of the water/aqueous medium to form the corresponding voids.

The invention further provides a process for forming a foam material, the process comprising
light-curing a resin in a form of a water-in-oil emulsion comprising at least one light-curable material (e.g., a monomer, oligomer polymer or prepolymer) to obtain a 3D structure having a predesigned/predetermined cell structure comprising a plurality of cells interconnected through walls defining same, said walls comprising randomly distributed and randomly sized plurality of water-filled pockets;
and
optionally causing said water-filled pockets to empty, to thereby provide a dry or water-free foam material.

The invention further provides a process for manufacturing a dry (dehydrated or water-free) porous polymeric structure (or foam), the process comprising:
light-curing a water-in-oil emulsion comprising at least one light-curable material (e.g., a monomer, oligomer polymer or prepolymer) to obtain a 3D structure having a predesigned/predetermined cell structure comprising a plurality of cells interconnected through walls defining same, said walls comprising randomly distributed and randomly sized plurality of water-filled pockets (thus obtaining a wet or a partially wet form of the foam);
and
causing said water-filled pockets to empty to provide the dry or water-free porous polymeric structure of foam.

The invention further provides a process for manufacturing a dry (dehydrated or water-free) porous polymeric structure (or foam) having a multiscale porosity defined by a predesigned macrometric cell structure (having a predesigned cell size, cell shape, cell connectivity, cell distribution, and cell density) and a random micrometric pore structure (defined by a random pore shape, size and distribution), the process comprising
light-curing by 3D printing a water-in-oil (W/O) emulsion comprising a water phase and an oil phase comprising at least one light-curable (e.g., UV-curable) material (e.g., a monomer, oligomer polymer or prepolymer with a proper photoinitiator), to obtain the polymeric structure having the predesigned macrometric cell structure; and
treating the polymeric structure having the predesigned macrometric cell structure to evaporate or remove water contained within the micrometric pores formed in said polymeric structure, to form the random micrometric pore structure in walls interconnecting said cells in said macrometric cell structure.

The water may be made to evaporate or remove from the wet foam by thermal treatment of the wet or water-containing foam, or by applying a vacuum or by extraction with a solvent. The expression “causing said water-filled pockets to empty” or “treating the polymeric structure . . . to evaporate or remove water” means treating the water-containing foam under conditions causing the removal or evaporation of the water contained in the water-filled pockets. These conditions may include increasing the temperature of the foam, treating the foam under vacuum, extraction by a volatile solvent (solvent exchange) and other conditions as known to a person versed in the art.

The porous material or structure or foam of the invention is a porous structure having two levels of porosity: a first porosity level that is predefined or predetermined and which is achieved by printing; and a second porosity level that is random and which is achieved by using the resin emulsion. The foam material may be thus characterized as having a multiscale porosity with pores ranging from a few nanometers to several millimeters or centimeters (cells). The unique mechanical properties of foam materials of the invention depend, to some extent, on the unique pore hierarchy. The multiscale hierarchy improves deformation mechanisms at the pore level as bending and stretching of the cell walls, which are themselves porous or contain voids of various micrometric dimensions, allow for a further improvement in their elasticity. The cell wall bending strength may, but not necessarily, be affected by the pore size where the smaller pores allow for a higher strength due to increasing strength of pore edges. However, since the mechanical properties of such porous materials may be influenced by the larger cells, the morphological imperfections associated with non-uniform cell wall thickness, cell size variations, fractured cell walls, cell wall misalignments, and others, the process of the invention dramatically limits such variations by the predesign of the macrometric cell structure, thereby resulting in overall improved flexibility, and generally a greater mechanical strength.

The foams may be 2D honeycomb-like structures, 3D structures with an open cell configuration (wherein the pores are connected by struts or supports or walls), 3D structures with a closed cell configuration (wherein the pores are fully enclosed within pore walls), or mixed forms wherein both open and closed cells are present.

In some embodiments, the foam of the invention is of the open-cell configuration, formed of predesigned open cells connected by walls having micrometric pore structure. In some embodiments, the foam is of the closed-cell configuration, formed of predesigned pores or cavities that are enclosed within walls having micrometric pore structure.

The term “foam” thus encompasses both a dry foam, a hydrated foam that has not been vacated of water, a dehydrated form that has been vacated of water, a foam that has been re-hydrated, or a foam that comprises pores of any size that are fully or partially provided with at least one material or composition, e.g., aqueous or non-aqueous.

The foam may be regarded as “water-free”, namely not containing any amount of water, or containing an amount of water that is trapped or cannot be easily removed without risking the integrity or mechanical stability of the foam structure. Typically, water-free forms of the foam structures do not include water in amounts greater than 1%. The foams are polymeric in composition, typically thermoset in nature. The foams may be formed of any polymer generated by light-curing of a light-curable material as disclosed herein. The resulting polymer may be an epoxy, a silicone, a polyurethane, a phenolic polymer or any other such polymer known in the art. In some cases, the polymer is polyurethane acrylate (PUA), formed, for example, from a resin comprising urethane acrylate.

As disclosed herein, foams of the invention are formed by 3D digital printing, more specifically by a 3D printing method involving light curing. The polymeric porous structure, foam, or object, as used herein interchangeably, may be formed by a variety of printing methods which involve curing of the resin, i.e., the W/O emulsion, by exposing the resin to light of a wavelength being in the UV, NIR or visible range. The light-mediated curing may involve deposition of the resin in a layer-by-layer sequence, whereby each layer is irradiated and cured before the next layer is deposited. Alternatively, the resin may be contained in a resin bath that is illuminated or irradiated to cause curing of the resin. The light-mediated curing may involve stereolithography, DLP or volumetric printing, where a light beam such as a laser is scanned over the resin bath to form a layer of hardened material. A platform may be used to move the foam being formed downwards by one layer thickness as the foam is formed. In other configurations, the light curing may be similarly used, with the light beam, e.g., laser, focusing on the bottom of the bath, or at a specifically selected location within the bath to construct the foam. Thus, the printing method may be any one of the printing methods known for producing 3-dimentional objects involving use of light irradiation. Such methods may include Digital Light Processing (DLP), stereolithography (SLA), Direct Ink Write (with light irradiation), Polyjet printing, volumetric printing, two-photon polymerization printing, extrusion deposition and others.

In some embodiments, the light curing process is DLP, SLA or volumetric printing. In some embodiments, the light curing process or the 3D printing method is DLP.

The resin used in forming the foam or porous object is generally a W/O emulsion, W/O nanoemulsion or a W/O microemulsion, wherein water is a dispersed phase and a light-curable material acts as a continuous phase. The light-curable material contained in the resin is any light-sensitive water-insoluble material capable of being cured by light of a given wavelength and in presence of a suitable photoinitiator(s). In other words, the light-curable material is one or a mixture of two or more such materials that are (each or in combination) capable of undergoing one or more chemical reactions to form stable covalent bonds, e.g., crosslinking or polymerization into a stable solid thermoset material. The light-mediated curing may be achieved by irradiating the resin bath comprising a light-curable material in a form of a monomer, oligomer, prepolymer or a polymer unit of the polymeric material forming the object. The light wavelength selected for causing curing or polymerization may be selected based on the material used.

The light-mediated curing or polymerization may be achievable by UV irradiation or visible light irradiation or NIR irradiation. Light irradiation may be achieved by using a projection unit such as a DLP projector, a LED projector, an LCD projector, a laser source, an electron beam, or any other light emitting unit, operating at a desired wavelength, at a direction of the resin bath or the resin material. The irradiation wavelength may depend on the type of initiators used for enabling the photocuring.

The light-curable material, whether in a form of monomers or oligomers or prepolymers or mixtures thereof, has a polymerizable group or q functionality that can be activated by photopolymerization reaction. The polymerizable group or functionality may be an acrylic or a vinyl group or functionality. Such materials include, but are not limited to, acrylates and methacrylates, styrenic compounds, vinyl ethers, aromatic compounds with vinyl groups (such as N-vinyl carbazoles), epoxides, urethanes, lactones, thiolenes, lactams, cyclic ethers, cyclic acetals, cyclic siloxanes, polyethers, polyesters, maleimides and allyl compounds.

In some embodiments, the light-curable material is a UV-curable material.

In some embodiments, the light-curable material is a material having a reactive double bond, such as an acryloyl (H₂C═CH—(C═O)-) functionality or a vinyl (H₂C═CH-) functionality.

In some embodiments, the light-curable material is a mixture of urethane (ethyl carbamate) and an acrylate (such as methyl acrylate, ethyl acrylate, butyl acrylate and others) or acrylic acid. In some embodiments, the light-curable material is a mixture of urethane and acrylic acid.

In some embodiments, the light curable material is urethane acrylate.

The urethane acrylate is a group of compounds having a urethane bond and an acrylate group. The urethane acrylate may defined based on the number of acrylate end groups and may thus be selected from monofunctional urethane acrylates, bifunctional urethane acrylates, trifunctional urethane acrylates and higher homologues, such as tetra and hexafunctional urethane acrylates or polyfunctional derivatives. The urethane bond(s) present in the urethane acrylate is/are formed by a polymerization reaction between an isocyanate-based monomer and a polyol.

In some embodiments, the urethane acrylate contains urethane linkages and acrylate or methacrylate functional groups. The urethane acrylate may thus be urethane multi-methacrylate, multi-urethane methacrylate, or multi-urethane multi-methacrylate. Further examples of urethane acrylates are known from, e.g., U.S. Pat. No. 4,608,409, U.S. Pat. No. 6,844,950, hereby incorporated by reference. Other urethane acrylates are commercially available from commercial sources such as Bomar, Arkema and others.

In some embodiments, the weight ratio between the acrylate monomer, e.g., methacrylate-based monomer, and the urethane may be around 1:1.

In some embodiments, the light-curable material is acryl polydimethyl siloxane. The photoinitiator is a material as known in the art. Typically, the photoinitiator is any material that absorbs photons upon irradiation with light and forms reactive species and/or heat, which initiate consecutive reactions. The initiating species may be radicals, cations, or anions. In some cases, heat causes reaction initiation. The selection of a suitable photoinitiator or a combination of such materials may depend, inter alia, on the wavelength range the light-curing material may be reactive, the presence of more than one light-curable materials and the conditions of the curing reaction.

The photoinitiator may be selected amongst cationic, anionic, and radical photoinitiators. Non-limiting examples of photoinitiators include bis(2,4,6-trimethylbenzoyl)-phenylphosphineoxide (Irgacure 819), 2-benzyl-2-(dimethylamino)-4′-morpholinobutyrophenone (Irgacure 369), 1-Hydroxycyclohexyl phenyl ketone (Irgacure 184), bis-(4-methoxybenzoyl)diethylgermanium (Ivocerin), 2,3-bornanedione (camphorquinone), lithium phenyl-2,4,6-trimethylbenzoylphosphinate (LAP), Riboflavin-5-phosphate, 2,2-dimethoxy-1,2-diphenylethan-1-one, bis(2,4,6-trimethylbenzoyl)-phenylphosphine oxide, 1-hydroxycyclohexyl benzophenone, trimethyl-benzoyl-diphenyl-phosphine-oxide, bis(eta-5-2,4-cyclopentadien-1-yl)bis[2,6-difluoro-3-(1H-pyrrol-1-yl) phenyl]titanium, 5,7-diiodo-3-butoxy-6-fluorone, (eta 5-2,4-cyclopentadien-1-yl) (eta6-isopropylbenzene)-iron(II) hexafluorophosphate, Diphenyl(2,4,6-trimethylbenzoyl)phosphine oxide (TPO), Phenylbis(2,4,6-trimethylbenzoyl)phosphine oxide (BAPO) and others.

The photoinitiator may be present in the resin at a concentration between 0 and 5%.

In some cases, the resin may contain one or several photoinitiators, and one or several polymerizable materials. In some cases, localized polymerization can be achieved by using several light sources tailored to yield localized polymerization of different materials.

The W/O emulsion resin contains an amount of water that does not cause phase inversion to an oil-in-water emulsion. Typically, the amount of water in the emulsion does not exceed or is not greater than 70 wt % 55 wt % or 45 wt %, depending on the selection of components used. In some embodiments, the water content is between 4 wt % and 35 wt %.

The amount of the light-curable material(s) in the resin may be between 35 wt % and 90 wt %.

The resin that may include water, at least one light-curable material, a photoinitiator and one or more additives which may be functional or act as fillers. The one or more additive may be selected from crosslinking agents, polymerization initiators, colorants, stabilizers, water-soluble materials, radical scavenging agents, surfactants, wetting agents, polymers, UV absorbers, conductive materials such as carbon nanotubes, metallic particles, nanoparticles, and others.

In some embodiments, the emulsion may comprise water, at least one light-curable material, at least one surfactant, at least one photoinitiator and optionally one or more additives. The surfactant may be a single surfactant or a combination of two or more such materials with a measurable Hydrophile-Lipophile Balance (HLB) of between 1 and 20 or between 3 and 20 or a polymeric surfactant.

In some embodiments, the surfactant is or comprises an ethylene oxide-propylene oxide copolymer having a HLB of between 1 and 3 and an average molecular weight of about 4400. In some embodiments, the surfactant is or comprises poly(ethylene glycol)-block-poly(propylene glycol)-block-poly(ethylene glycol). The surfactant may be commercially available under PluronicL 121.

A further surfactant may be used instead or in combination in order to reduce the surface tension of the emulsion when used as an ink for forming the printed objects. Such an additional surfactant may be selected amongst silicone-based surfactant or non-silicone ones. The silicon-based surfactants may be selected amongst cationic, anionic, and nonionic silicone surfactants. In some embodiments, the silicone-based surfactant is a nonionic surfactant based on methicone or dimethicone. In some embodiments, the silicon-based surfactant may be a modified polyether-polysiloxane, or silicone surfactants as known for example from EP2970668.

In some embodiments, the silicone surfactant may be ABIL 90.

In some cases, the silicone-based surfactant mentioned hereinabove may be used as the sole surfactant or in combination with another surfactant.

In some embodiments, the surfactant is a combination of poly(ethylene glycol)-block-poly(propylene glycol)-block-poly(ethylene glycol) and a modified polyether-polysiloxane.

In some embodiments, the amount of the surfactant or a combination of surfactants in the emulsion may be between 0.5 and 20 wt %. The amount and type of the surfactant may be varied in order to vary the water droplets sizes and therefore the eventual size of the micrometric pores formed in the foam.

The emulsion may further comprise a radical scavenging agent, such as hydroquinone (HyQ), and/or a light absorber such as sulforhodamin B (SolB).

In some embodiments, the emulsion may comprise 35 wt % of water and 4 wt % of at least one surfactant.

Apart from the additives which may be introduced into the emulsion to endow the emulsion or the final product with certain additional qualities or characteristics, hyperelastic materials may be introduced. The hyperelastic material may be selected amongst such materials that can undergo nonlinear elastic deformations, and which may be a polymer, e.g., an elastomer, having hyperelastic properties, in particular high reversible extensibility. The hyperelastic material may be selected from elastomers, thermoplastic elastomers, thermoplastic polyamide elastomers, thermoplastic copolyester elastomers, olefin-based thermoplastic elastomers, thermoplastic styrene block copolymers, urethane thermoplastic elastomers, olefin-based thermoplastic vulcanizates, crosslinked olefin-based thermoplastic elastomers, vulcanizates of natural rubbers, vulcanizates of synthetic rubbers, styrene-butadiene rubber, butadiene rubber (BR), Acrylonitrile-butadiene rubber (NBR), butyl rubber (IIR), ethylene-propylene-diene rubber (EPDM), chloroprene rubber (CR), polyisoprene rubber (IR), polyalkylsiloxanes, polydimethylsiloxane, silicone rubbers, silicone elastomers, methyl silicone, vinyl-methyl-silicone, phenyl-vinyl-methyl-silicone, phenyl-modified silicone, fluoroalkyl-silicone, fluoro-vinyl-methyl-silicone and others.

In some embodiments, the at least one light curable material is a mixture of light curable materials, wherein one or more of which results after polymerization in a hyperelastic material or one or more elastomers.

By inducing photocuring or photopolymerization utilizing UV or visible light curing, a polymeric foam or a polymeric object having a predesigned 3D structure with a predesigned macrometric cell structure may be formed. As used herein, the “macrometric cell structure” refers to the visible cell pattern of the foam comprising a plurality of same or different predesigned cells which may be open or enclosed by walls, wherein the shape, size, position, density, distribution and connectivity is predesigned, not random. As the cells are at least several micrometers or millimeters in size (measured along any axis thereof), they are referred to as “macrometric”. In some configurations, the dimensions are at least 2 mm and up to 50 mm. In other cases, the dimensions may be between 2 mm and 2 cm.

Typically, each cell of the macrometric pore structure is separated from a neighboring cell (which may or may not be of the same size and shape) by a wall (connecting or interconnecting wall) that defines the structure, shape, and size of the cell. As discussed herein, the walls are composed of a polymeric material formed by curing or polymerization of the W/O resin comprising water and the light-sensitive material. Upon curing, water droplets are formed within the cured material and are trapped in a way to form the cavities or pockets in the cured polymer. Upon dehydration (by way of thermal treatment of the hydrated foam, or by applying a vacuum or by extraction with a solvent) these pockets or droplets empty to provide the random micrometric pore structure, wherein the pore shapes, sizes and distribution are not predefined, rather are random. The size and shape of the pores may depend on the initial droplet size of the emulsion and the shape of the cavities in which the water is trapped, and thus cannot be predesigned by conventional printers. As their size and shape may further change upon dehydration, this pore structure is random and typically characterized by pores or pockets having dimensions in the nanometric to millimetric range, thus being referred to in general as “micrometric”.

The term “predesigned” or “predetermined” or “predefined” made in connection with the macrometric cell structure means that the cell structures and cell dimensions, as well as cell interconnectivity, wall arrangement, wall thickness and shape may be predesigned by forming a 3D design using a 3D software program. The 3D cell structures may be then formed by the 3D printer using a digital light processing to project the image with a light of a given wavelength, e.g., UV light, onto the resin bath or the resin.

In some embodiments, the cells of the macrometric structure may be 2 to 50 mm in dimension (length, height, width etc), while the size of the micrometric pores formed in walls of said cells and defining the random micrometric pore structure may be between 50 nm and 10 μm.

In some embodiments, the micrometric pores are of a size range from 1 to 10 μm, with an average size of about 3 μm.

The resin used in the manufacturing of foams and objects of the invention enables formation of highly stretchable and compressible porous structures with controllable mechanical properties that can be tailored by changing the printing compositions such as the dispersed phase fraction of the water. High water content in the resin emulsion will result in highly porous and low-density foams, and vice versa. The unique pore hierarchy, which is achieved by design (a predesigned 3D protocol) and by composition (the ink constitution), improves the foam mechanical performance and opens the door for a great variety of applications, ranging from low-density polymeric foams, which may be tailored as energy absorbing materials or as reinforcement materials to high density foams, which may be used as mattresses, seating, and cushions.

The foams exhibit superior stretchability and are exceptionally reliable and versatile material that afford applications in a variety of other fields, including personalized design, impact resistance, thermal insulation, soft robotics, printed electronics, smart packaging, personal protection and others. The innovative approach opens exciting possibilities by implementing the emulsion method with other hyperelastic materials, to create novel foams with complex structures and tailored functionalities. The resulting foam can be stretched up to 500%, while rapidly recovering its original dimensions. The typical mechanical properties are discussed and presented hereinbelow.

Thus, uses of materials/foams of the invention may be classified as follows:
Shock absorption: The compressible nature of the foam may be used to absorb shock in a variety of defense, sports and rehabilitation applications, such as in the fabrication by 3D printing of customized protective gear for personnel and vehicles or for the protection of delicate electronics and other sensitive equipment, and for making personalized internal part of helmets for pilots and motorcycles and bicycles riders.
Camouflage patterns or objects: Moreover, the high-resolution 3D printing capabilities of the foam, determined according to a predesign and to some extent also on printer resolution used, may be used to form customized camouflage patterns on a surface of protective gear that blend in with specific environments.
Soft robotics: Conventional vehicle maneuvering uses the air pressure in the tires to achieve compressibility. The polymeric foams of the invention present a solution for navigation in tight spaces and rough terrain by maximizing traction, stability, and cushioning for soft robots. Moreover, soft robots made of compressible foams can adapt their structures and gently and precisely grip delicate objects. It can be used as part of a soft gripper, capable of grasping objects with variable shape, texture and rigidity, such as vegetables, fruits and mushrooms. This can be also useful for handling dangerous ammunition and weapons, especially in high-risk situations such as bomb disposal or handling hazardous materials. Thus, reducing the risk of injury or death for personnel involved compared to common rigid manipulators.
Medical applications: For civilian applications, the foam's compressible and stretchable properties combined with 3D printing could be utilized in the creation of prosthetics or other medical devices that need to conform to the body's movements and contours, such as a customized prosthetic hand that can absorb shock and provide a more comfortable fit tailored to the individual's specific activity level.

Also, 3D scanning may be used to obtain mapping of a person's internal organ. This scan may be used to form a 3D printable file, and on the basis of which 3D print a foam with required dimensions and structure. The structure may be used as an implant or a replacement member.

Each of the stated uses mentioned constitutes a separate and independent embodiment of the invention.

The invention further provides:

A 3D printed polymeric foam having a multiscale porosity comprising predesigned macrometric cells connected by porous walls having a random micrometric pore structure, and wherein the macrometric cells and micrometric pore structure having a size ranging from 5 nm to 2 cm.

In all configurations and permutations of foams and objects of the invention, the foam or object is optionally stretchable or flexible.

In all configurations and permutations of foams and objects of the invention, the foam or object optionally has multiscale porosity with pores ranging from 5 nm to 50 μm.

In all configurations and permutations of foams and objects of the invention, the foam or object optionally has macrometric cells which comprise a plurality of interconnected cells having a size ranging between 2 mm and 50 mm, and wherein the cells having walls with micrometric pore structures comprising a plurality of pores having a size ranging between 5 nm and 50 μm.

In all configurations and permutations of foams and objects of the invention, the foam or object optionally has micrometric pore structures comprising a plurality of pores having a size ranging between 50 nm and 10 μm.

In all configurations and permutations of foams and objects of the invention, the foam or object optionally has micrometric pore structure comprising a plurality of pores having a size ranging between 1 and 10 μm.

In all configurations and permutations of foams and objects of the invention, the foam or object optionally has micrometric pore structure comprising a plurality of pores having an average size of about 3 μm.

In all configurations and permutations of foams and objects of the invention, the foam or object optionally has a form that is a hydrated form, wherein the micrometric pore structures comprising a plurality of pores containing water or a medium comprising water.

In all configurations and permutations of foams and objects of the invention, the foam or object optionally has a form that is a dehydrated or a water-free form.

In all configurations and permutations of foams and objects of the invention, the foam or object optionally is a stretchable foam material having a pore hierarchy design characterized by micrometric pores present in interconnective walls of the macrometric cells, wherein the interconnective walls of the macrometric cells are formed by 3-dimentional printing and wherein the micrometric pore structures are formed by photocuring of a water-in-oil emulsion comprising a light-curable material.

In all configurations and permutations of foams and objects of the invention, the foam or object optionally has a stretched state with at least one dimension that is at least 100% of the same at least one dimension measured for its unstretched state.

In all configurations and permutations of foams and objects of the invention, the foam or object optionally has a stretched state with at least one dimension that is at least 200, 300, 400 or 500% of the same at least one dimension measured for its unstretched form.

In all configurations and permutations of foams and objects of the invention, the foam or object is optionally formed of polyurethane acrylate.

In all configurations and permutations of foams and objects of the invention, the foam or object optionally has a 2D honeycomb-like structure; a 3D structure with an open cell configuration wherein the pores are connected by struts or supports or walls; a 3D structure with a closed cell configuration wherein the pores are fully enclosed within pore walls, or mixed forms wherein both open and closed cells are present.

A process is provided for forming a foam or a porous object, the process comprising light curing a resin in a form of a water-in-oil (W/O) emulsion comprising at least one light-curable material to obtain a predesigned 3D porous structure comprising interconnected cells, wherein walls interconnecting the cells comprise micrometric pores having random sizes and pore distribution.

In all configurations and permutations of foams and objects of the invention, the process for making the foam or object optionally provides at least a portion or all of the micrometric pores formed as volatile water or liquid droplets or pockets.

In all configurations and permutations of foams and objects of the invention, the process for making the foam or object optionally comprising
light curing a resin in a form of a W/O emulsion comprising at least one light-curable material and at least one photoinitiator to obtain a 3D structure having a predesigned/predetermined cell structure comprising a plurality of cells interconnected through walls defining same, said walls comprising randomly distributed and randomly sized plurality of water-filled pockets; and
optionally causing said water-filled pockets to empty to provide a dry or water-free foam.

In all configurations and permutations of foams and objects of the invention, the process for making the foam or object optionally is for manufacturing a dry, or dehydrated or water-free porous polymeric structure or foam, the process comprising:
light curing a resin in a form of a W/O emulsion comprising at least one light-curable material and a at least one photoinitiator to obtain a 3D structure having a predesigned/predetermined cell structure comprising a plurality of cells interconnected through walls defining same, said walls comprising randomly distributed and randomly sized plurality of water-filled pockets; and
causing said water-filled pockets to empty to provide the dry or water-free porous polymeric structure of foam.

Also provided is a process for manufacturing a dry or dehydrated or water-free foam or a porous polymeric object having a multiscale porosity defined by predesigned macrometric cells and random micrometric pore structures, the process comprising
3D printing and light curing a water-in-oil (W/O) emulsion comprising a water phase and an oil phase comprising at least one light-curable material and a photoinitiator, to obtain a polymeric structure having the predesigned macrometric cells; and
treating said polymeric structure to remove water contained within micrometric pores formed in said polymeric structure, to form the random micrometric pore structures in walls interconnecting the macrometric cells.

In all configurations and permutations of foams and objects of the invention, the predesigned macrometric cells having a predesigned cell size, cell shape, cell connectivity, cell distribution, and/or cell density.

In all configurations and permutations of foams and objects of the invention, the process for making the foam or object optionally makes foams with random micrometric pore structure having a random pore shape, pore size and/or pore distribution.

In all configurations and permutations of foams and objects of the invention, the process for making the foam or object optionally is a printing or a 3D printing selected from Digital Light Processing (DLP), stereolithography (SLA), Direct Ink Write (with light irradiation), Polyjet printing, Volumetric Printing, Two Photons Polymerization printing and extrusion deposition.

In all configurations and permutations of foams and objects of the invention, the process for making the foam or object optionally is DLP.

In all configurations and permutations of foams and objects of the invention, the process for making the foam or object optionally has W/O emulsion that is a W/O nanoemulsion or a W/O microemulsion, wherein water is a dispersed phase and the light-curable material is a continuous phase.

In all configurations and permutations of foams and objects of the invention, the process for making the foam or object optionally involves a light-curable material that is a light-sensitive water-insoluble material capable of undergoing curing under UV, NIR or visible light, in presence of a photoinitiator.

In all configurations and permutations of foams and objects of the invention, the process for making the foam or object optionally a light-curable material is one or a mixture of two or more materials capable of undergoing one or more chemical reactions to form stable covalent bonds.

In all configurations and permutations of foams and objects of the invention, the process for making the foam or object optionally a light-curable material is a monomer, oligomer, prepolymer or a polymer unit of the polymeric material forming the object or foam.

In all configurations and permutations of foams and objects of the invention, the process for making the foam or object optionally light curing is achievable by UV irradiation or visible light irradiation or NIR irradiation.

In all configurations and permutations of foams and objects of the invention, the process for making the foam or object optionally light curing is achievable by light emission from a projection unit.

In all configurations and permutations of foams and objects of the invention, the process for making the foam or object optionally has a projector unit that is a DLP projector, a LED projector, an LCD projector, or a laser source.

In all configurations and permutations of foams and objects of the invention, the process for making the foam or object optionally light curing comprises irradiation by light having a wavelength capable of initiating photocuring.

In all configurations and permutations of foams and objects of the invention, the process for making the foam or object optionally light-curable material has a polymerizable group selected amongst acrylic and vinyl functionalities.

In all configurations and permutations of foams and objects of the invention, the process for making the foam or object optionally has a light-curable material that is selected amongst acrylates, methacrylates, styrenic compounds, vinyl ethers, aromatic compounds having vinyl groups, epoxides, urethanes, lactones, thiolenes, lactams, cyclic ethers, cyclic acetals, cyclic siloxanes, polyethers, polyesters, maleimides and allyl compounds.

In all configurations and permutations of foams and objects of the invention, the process for making the foam or object optionally has a light-curable material that is selected from urethane acrylates and acryl polydimethyl siloxane.

In all configurations and permutations of foams and objects of the invention, the process for making the foam or object optionally has a light-curable material that is a UV-curable material.

In all configurations and permutations of foams and objects of the invention, the process for making the foam or object optionally has a light-curable material that is urethane acrylate.

In all configurations and permutations of foams and objects of the invention, the process for making the foam or object optionally has a W/O emulsion that comprises an amount of water not causing phase inversion to an oil-in-water emulsion.

In all configurations and permutations of foams and objects of the invention, the process for making the foam or object optionally has an amount of water in the emulsion does not exceed or is not greater than 70 wt %.

In all configurations and permutations of foams and objects of the invention, the process for making the foam or object optionally has an amount of water that is not greater than 55 wt %, or is not greater than 45 wt %, or is between 4 wt % and 35 wt %.

In all configurations and permutations of foams and objects of the invention, the process for making the foam or object optionally has a W/O emulsion comprising between 35 wt % and 90 wt % of the light-curable material.

In all configurations and permutations of foams and objects of the invention, the process for making the foam or object optionally has a W/O emulsion comprising water, the at least one light-curable material, a photoinitiator and one or more additives selected from crosslinking agents, polymerization initiators, colorants, stabilizers, water-soluble materials, radical scavenging agents, surfactants, wetting agents, polymers, UV absorbers, conductive materials such as carbon nanotubes, metallic particles, and nanoparticles.

In all configurations and permutations of foams and objects of the invention, the process for making the foam or object optionally has a W/O emulsion comprising at least one surfactant having a Hydrophile-Lipophile Balance (HLB) between 1 and 20 or between 3 and 20.

In all configurations and permutations of foams and objects of the invention, the process for making the foam or object optionally has a W/O emulsion comprising at least one polymeric surfactant.

In all configurations and permutations of foams and objects of the invention, the process for making the foam or object optionally has a W/O emulsion comprising at least one surfactant being ethylene oxide-propylene oxide copolymer having a HLB of between 1 and 3 and an average molecular weight of about 4400.

In all configurations and permutations of foams and objects of the invention, the process for making the foam or object optionally has a W/O emulsion comprising at least one surfactant being poly(ethylene glycol)-block-poly(propylene glycol)-block-poly(ethylene glycol).

In all configurations and permutations of foams and objects of the invention, the process for making the foam or object optionally has a W/O emulsion comprising a surfactant combination of poly(ethylene glycol)-block-poly(propylene glycol)-block-poly(ethylene glycol) and a modified polyether-polysiloxane.

In all configurations and permutations of foams and objects of the invention, the process for making the foam or object optionally has a W/O emulsion comprising a radical scavenging agent.

In all configurations and permutations of foams and objects of the invention, the process for making the foam or object optionally has a W/O emulsion comprising a hyperelastic material.

In all configurations and permutations of foams and objects of the invention, the process for making the foam or object optionally has a hyperplastic material that is selected from elastomers, thermoplastic elastomers, thermoplastic polyamide elastomers, thermoplastic copolyester elastomers, olefin-based thermoplastic elastomers, thermoplastic styrene block copolymers, urethane thermoplastic elastomers, olefin-based thermoplastic vulcanizates, crosslinked olefin-based thermoplastic elastomers, vulcanizates of natural rubbers, vulcanizates of synthetic rubbers, styrene-butadiene rubber, butadiene rubber (BR), acrylonitrile-butadiene rubber (NBR), butyl rubber (IIR), ethylene-propylene-diene rubber (EPDM), chloroprene rubber (CR), polyisoprene rubber (IR), polyalkylsiloxanes, polydimethylsiloxane, silicone rubbers, silicone elastomers, methyl silicone, vinyl-methyl-silicone, phenyl-vinyl-methyl-silicone, phenyl-modified silicone, fluoroalkyl-silicone, and fluoro-vinyl-methyl-silicone.

A foam is disclosed that is formed by a process according to the invention.

In all configurations and permutations of foams and objects of the invention, the foam or object optionally is a porous object characterized by a multiscale porosity comprising predesigned macrometric cells connected by porous walls having a random micrometric pore structure, wherein the cells and pore structures having a size ranging from 5 nm to 2 cm, and wherein the material is formed of the light-curable material.

In all configurations and permutations of foams and objects of the invention, the foam or object optionally is such wherein the cells and pore structures having a size ranging from 5 nm to 50 μm.

In all configurations and permutations of foams and objects of the invention, the foam or object optionally has macrometric cells that comprise a plurality of interconnected cells having a size ranging 2 μm and 50 mm, and wherein the cells having walls with micrometric pore structures comprising a plurality of pores having a size ranging between 5 nm and 50 μm.

In all configurations and permutations of foams and objects of the invention, the foam or object optionally is for use as a shock absorber.

In all configurations and permutations of foams and objects of the invention, the foam or object optionally is for use in a method of forming a camouflage pattern on a surface region of an object.

In all configurations and permutations of foams and objects of the invention, the foam or object optionally is for use in soft robotics.

In all configurations and permutations of foams and objects of the invention, the foam or object optionally is for use in soft robotics grippers.

In all configurations and permutations of foams and objects of the invention, the foam or object optionally is for use in a method of forming a medical device.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1. Schematic illustration of 3D printing by DLP of stretchable foams from a photopolymerizable emulsion.

FIGS. 2A-C. (A-B) 3D printed foams with complex structure before and after compression. (C) Comparative plot of various 3D printed foams classified by the 3D printing methods and materials type.

FIGS. 3A-B. (A) Average diameter of droplets at various concentrations of PL121 (B) Regression plot based on sets of three tensile tests of different surfactant concentrations.

FIGS. 4A-C. (A) Instability of emulsion ink in various water concentrations; up to 35%, the emulsion is too viscous to be printed, and above 50%, the emulsion is O/W type. (B) Regression plots based on sets of three tensile tests of different printable water concentrations. (C) Compressibility test of different printable water concentration, the inset plot presents the first 30% compressive strain.

FIGS. 5A-D. (A) Optical microscope images of the unpolymerized emulsion, (scale bar 10 μm). (B) SEM image of the polymerized emulsion, (scale bar 10 μm). (C) Comparison of droplet size distribution by kernel density estimation (KDE) of the emulsion, with the pore diameter distribution in the object after polymerization and water evaporation. (D) ATR-FTIR spectrum of emulsion before and after water evaporation. The inset presents the color of the printed cone before and after drying, in presence of CoCl₂ as a moisture indicator.

FIGS. 6A-B. (A) Schematic presentation of the self-designed force measurement setup. (B) Force measured for layer detachment from the FEP film at various concentrations of 0-3%.

FIGS. 7A-H. (A) STL representation of the pillars for evaluating the resolution. (B) Photograph of the pillars in different widths ranging from 150 to 500 μm (scale bar is 500 μm). (C-E) Photograph of 350 μm pillars of formulation containing both HyQ and SolB at 1-, 1.35- and 2-seconds exposure times, the white rectangle represents the dimensions of the original STL file. (F) Effect of addition of HyQ and SolB on printing resolution. (G) ATR-FTIR measurement of C—H and C═C stretching of the acrylate compared to epoxy C═O═C stretching at different exposure time. (H) DOC Double bond conversion (DOC) as a function of exposure time

### DETAILED DESCRIPTION OF EMBODIMENTS

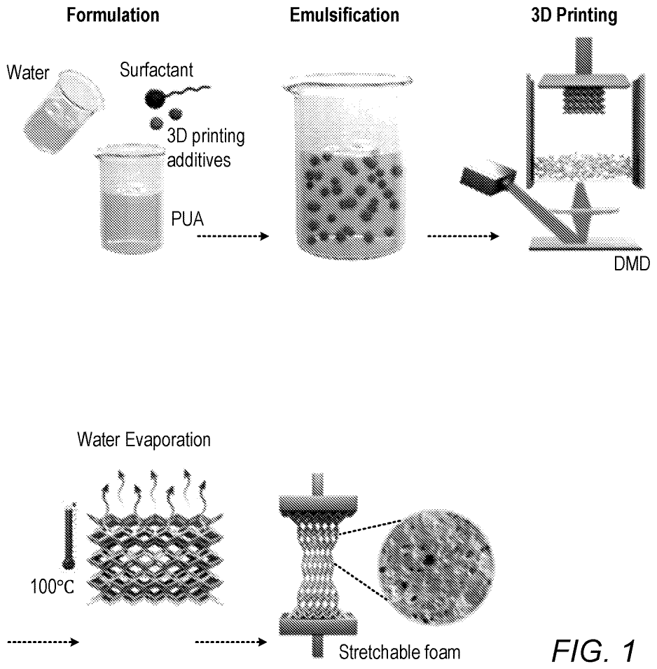

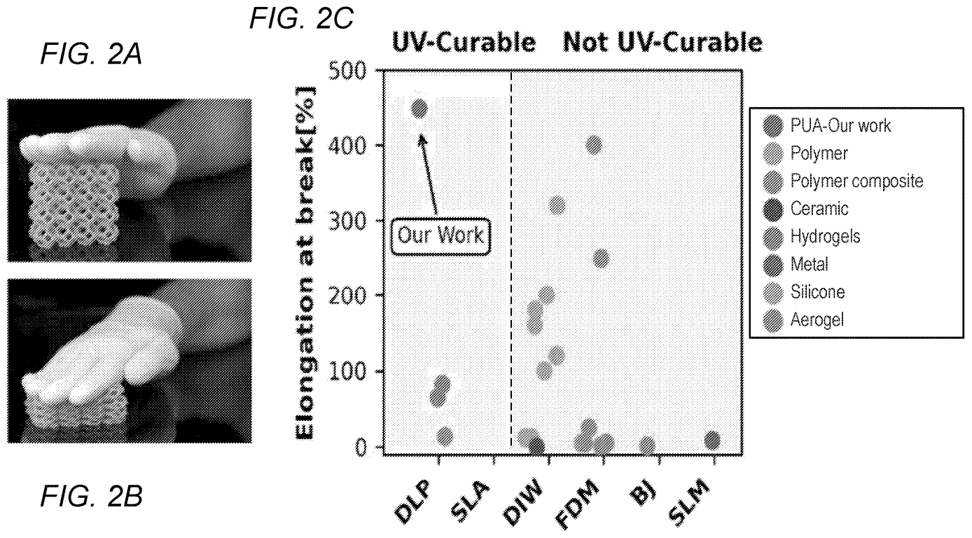

An overall process for fabricating 3D porous stretchable structures or foams by printing according to the invention is schematically presented in FIG. 1. As disclosed herein, a stable water-in-oil emulsion in which the continuous phase is a radiation polymerizable (visible light, UV, NIR, IR) material is formed by mixing the solution with a surfactant. Based on a predesign and localized photopolymerization, the ink formulation is deposited resulting in a stretchable polymeric structure with embedded water droplets. The water droplets may be subsequently removed from the hydrated or water-containing structure by evaporation or freeze drying, or by thermal treatment, resulting in a dry object containing microscopic pores. As presented in FIG. 2A-B, the printed object is cellular by design, while each of the walls is a stretchable foam by material's property. The structure is compressible and can be easily deformed by twisting and stretching, with a rapid and full recovery of the structure. In some embodiments, the object is not cellular, but is composed of 10% foam material with micropores only.

FIG. 2C presents comparison with prior art methods and products and shows that most of the porous objects known in the art are fabricated by materials that are not light or UV-curable, thus limiting their fabrication methods to low-resolution extrusion-based printing (DIW, FDM) or powder-based printing (Binder jetting (BJ) and Selective laser melting (SLM)).

The approach disclosed herein is first printing or stereolithography-based 3D-printed stretchable porous objects, having such a high value of elongation at break, and opens new opportunities in the fabrication of meta-materials, while combining materials properties and structural design. Since the building blocks of the technology are emulsion preparation methods, DLP printing and post-printing process of water removal, the production principals may be implemented at large scale productions.

### Material and Method

### Developing the Stretchable Foam by a Water in Oil (w/o) Polymerizable Emulsion

The first step in the process of making stretchable foam was to develop a printable emulsion that is stable for at least 24 hrs. When facing the development of a new emulsion, one must choose between hundreds of emulsifying agents. Griffith introduced in the late 1940s an empirical method for selecting emulsifiers, which is based on the Hydrophile-Lipophile Balance (HLB) system. By this method, an HLB number is assigned to the materials used for emulsification, thus enabling the selection of an emulsifier (or blend of emulsifiers) with the same number. To determine the required HLB of polyurethane acrylate, a series of emulsions using a blend of emulsifiers having a low and high HLB value were prepared at various ratios (emulsions containing 35 wt % water and 4 wt % emulsifiers). It was found that although the best emulsion was obtained by using a blend of Span 80 and Tween 80 with a ratio of 80/20, respectively, (calculated HLB of 6.4), this emulsion was stable for only less than 3 hours. Therefore, additional screening of polymeric surfactants was performed, which are also expected to provide steric stabilization. It was found that emulsion prepared with the surfactant Pluronic L121, had the best stability, 24 hr at room temperature, before phase separation occurred.

To find the optimal concentration of PL121, which enables the emulsion stability for 24 hours required for reliable printing, the effect of its concentration was evaluated for 0.5-16 wt %. The stability was determined by measuring the emulsion average droplet diameter and by the mechanical properties of the photocured emulsions samples after post-treatment.

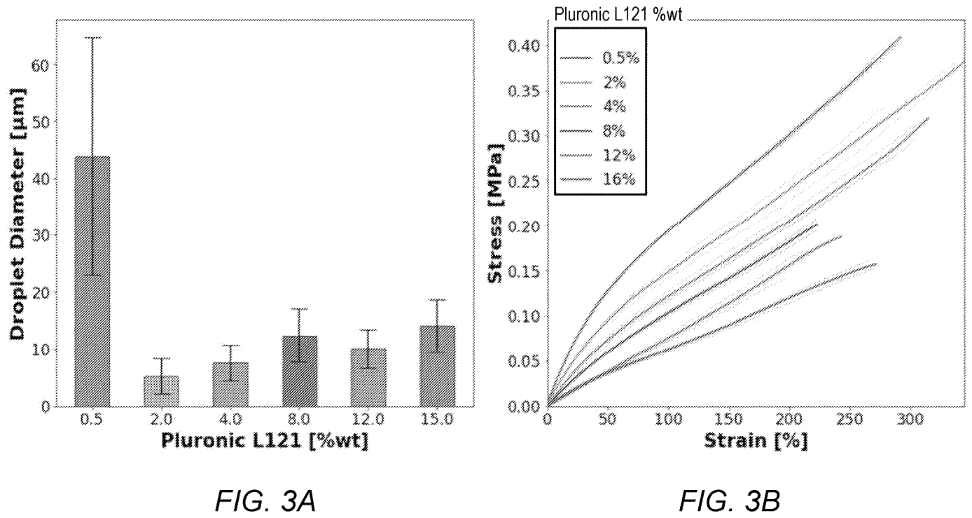

As shown in FIG. 3A, it was found that the droplet diameter significantly decreased from 45 μm to 3 μm while increasing the PL 121 concentration from 0.5 wt % 2 wt %, and slightly increased to droplets in the range of 3-15 μm from 4 wt % to 15 wt %. In addition, it was found that the formulations with concentrations of 2% and above were visually stable for at least 24 hours, and therefore they can be suitable for reliable printing.

The evaluation of the mechanical properties of the resulting polymerized and post-treated emulsions was performed by sets of three tensile measurements for each surfactant concentration, and the line is fitted with polynomial regression (FIG. 3B). It was found that as the PL 121 concentration increases from 0.5 wt % to 16 wt %, the stress at break (ultimate stress) decreases gradually from 0.40 to 0.15 MPa, while the strain at break is not significantly affected. Moreover, it was noticeable that increasing surfactant concentration above 4 wt % causes a drop in the ultimate stress to less than 0.25 MPa, and the strain decreases by approximately 100%. In addition, the curves of 12% wt and 16% wt surfactant show only a linear behavior, meaning that there is a loss of the elastic regime, and the curves present the strain-hardening region only, which from the practical point of view, such material behavior is undesired because it will easily fail and tend to be unpredictable.

In the emulsion-based ink, after water evaporation from the polymerized objects, the water droplets are converted into internal voids. Therefore, to test the limits of achievable porosity, we first evaluated the range in which the emulsion is of a W/O type, then we evaluated the emulsion instability as a function of the water fraction, and finally, the mechanical properties of the polymerized emulsions after water evaporation were measured.

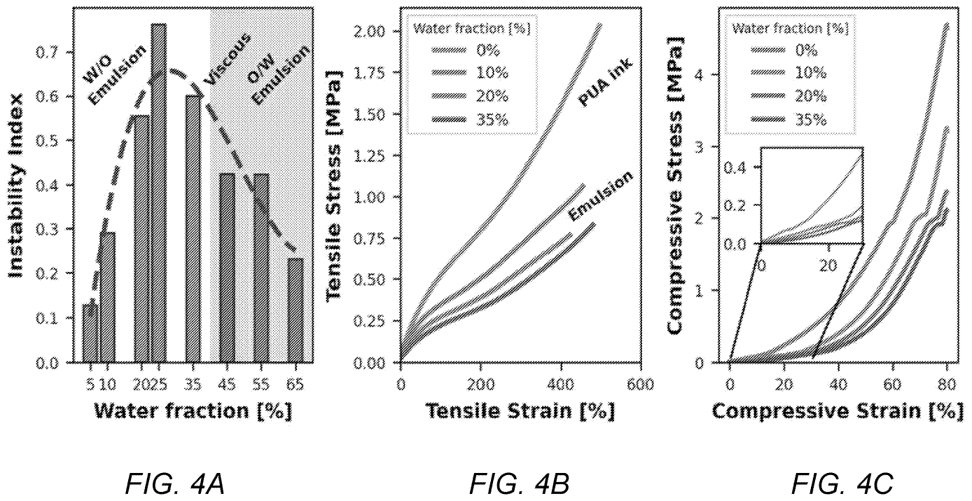

To test the range of W/O emulsions is formed, emulsions with water containing electrolytes were prepared, and the conductivity of each emulsion was measured. At low water fractions, the emulsions were not conductive, indicating that the continuous phase is the oil. It was found that at water content above 55% wt, the emulsion is conductive, meaning that a phase inversion occurred, and the PUA becomes the dispersed phase (O/W emulsion) instead of the continuous phase. It should be noted that at this water content, the polymerized emulsion disintegrated immediately after solidification. In addition to conductivity measurements, the instability index of the emulsions was measured with LUMiFuge analytical centrifuge. FIG. 4A presents the ranges in which the emulsions are O/W or W/O type and the dependence of the instability index on the water fraction. As seen, the emulsion instability increases with the increase in water concentration, and above 25 % wt the emulsion gradually stabilizes until entering the O/W emulsion regime at 50% water content. It should be noted that above 45% wt water fraction, the emulsion is too viscous for DLP printing. Therefore, 35 wt % was selected as the highest water concentration to be used for the printing formulations, and the evaluations of the mechanical properties of the polymerized emulsions after water evaporation were performed on emulsions with water content up to this value and with constant emulsifier concentration of 4 wt %.

The mechanical properties were evaluated in a similar analysis (polynomial regression on sets of three tensile measurements), as shown in FIG. 4B. The results show that the tensile stress at break significantly decreases from 0% water (PUA only, no emulsion) compared to the emulsions of PUA with different water fractions. More specifically, the stress at break decreases from 2.10 to 1.05 MPa when the water fraction changes from 0% to 10% water, and when increasing the water fraction in the emulsion from 10 wt % to 35%, the tensile stress at break decreases moderately from 1.05 to 0.77 MPa. Nevertheless, the tensile strain at break remained around 450% for all emulsions and is similar to the PUA itself (no emulsion). Based on these results, the photopolymerizable emulsion containing 35 wt % of water with 4 wt % of surfactant was further used as the basis for the printing formulations.

Typically, since hyperelastic materials do not allow for volumetric changes, they are nearly incompressible. However, thanks to the intrinsic internal porosity that arises from the emulsion, the material allows compressibility at significantly lower pressures. FIG. 4C presents the compressibility at different water content at up to 80% compressive strain. Overall, it was found that by increasing the water content, the material requires less pressure to allow for volumetric change, and thus this approach ensures high compliance and deformability. More specifically, at 80% compression, the compressive stress gradually reduces from 4.7 MPa to 2.1 MPa when the water content increases from 0% wt to 35%, respectively. Noteworthy, at approximately 2 MPa, all the formulations undergo an internal failure. However, increasing the water content from 0 % wt (no emulsion, failure at 55% strain) to 35% wt, the failure occurs at a significantly higher strain of 75%. In the inset plot of FIG. 4C, it is shown that for all the emulsion-based samples, the compressive strain increases linearly up to 30% strain, which means that the material exhibits structural deformability mainly due to the compression of the internal micropores. This is contrary to the PUA printing composition (0% water, not emulsion), which shows an exponential increase in compressive stress.

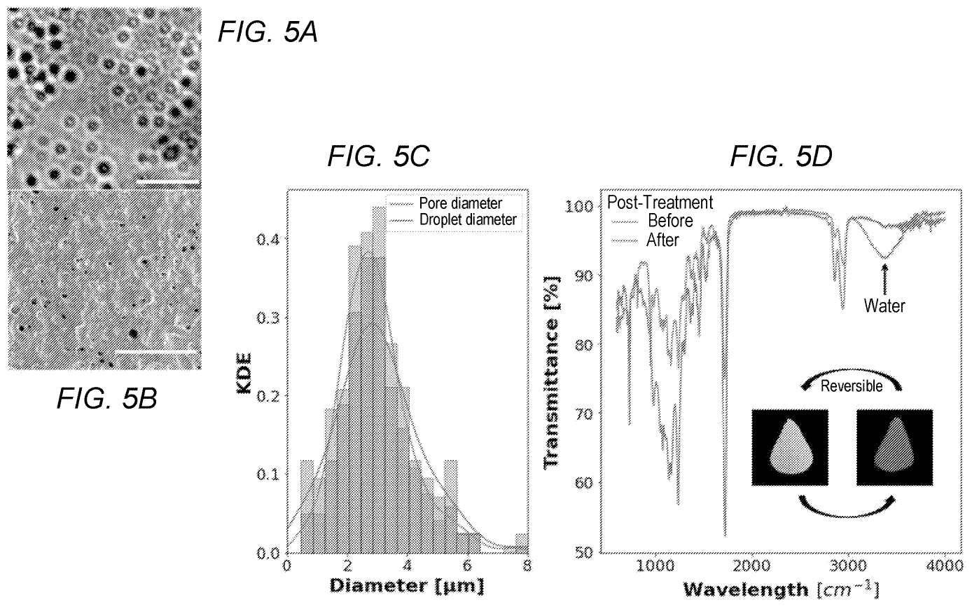

To characterize the formation of the pores from the selected emulsion (35% water, 4% surfactant), imaging of the emulsion by optical microscope and by SEM was done before and after the photo-curing and the water evaporation, as shown in FIG. 5A-B, respectively. Image analysis of these photos was performed by pore/droplet density fraction using Kernel Density Estimation (KDE) as a function of the measured pore/droplet size, as shown in FIG. 5C. It was revealed that the droplet size and the pore size are similar, when converting the droplets into internal voids upon water evaporation. The droplet and pore size range from 1 to 10 μm, with an average value of 3 μm. Moreover, as shown in FIG. 5B, the pores are interconnected, resulting in an overall open porous structure. This interconnection occurs due to the rupture of water droplets while evaporation in the post-curing heating process.

To verify if all the water was fully evaporated, the presence of water was checked by ATR-FTIR in the emulsion before and after post-treatment (heating to evaporate the water), and by a visual moisture indicator (FIG. 5D).

The lack of water was confirmed by the disappearance of the OH peak at 3380 cm⁻¹. Still, it should be noted that this evaluation gives information on a thin film and not on the whole bulk structure. Therefore, a visual moisture indicator, cobalt(II) chloride, was added to the water phase of the emulsion. When hydrated, the solution's color is pink, and the cobalt salt changes to blue when dehydrated. A cone structure was 3D printed while the droplets contained the cobalt salt. As shown in FIG. 5D inset, the whole structure turned from pink-white to blue after post-treatment, indicating a full drying of the printed model. It should be noted that the color change is reversible, meaning that by immersing the dried structure in water, the object turns pink-white again, thus validating the open-pore inner structure of the polymerized emulsion.

### 3d Printing by Digital Light Processing

The development of 3D printing process requires matching the printing compositions to the printing technology. For the DLP printing, the most important factors are the ink viscosity and stability, polymerization time, and compatibility with the printer components. The last requirement is related to obtaining, on one hand, adhesion to the printing platform and on the other hand, avoiding sticking to the vat window, which is composed of transparent FEP film (fluorinated ethylene propylene).

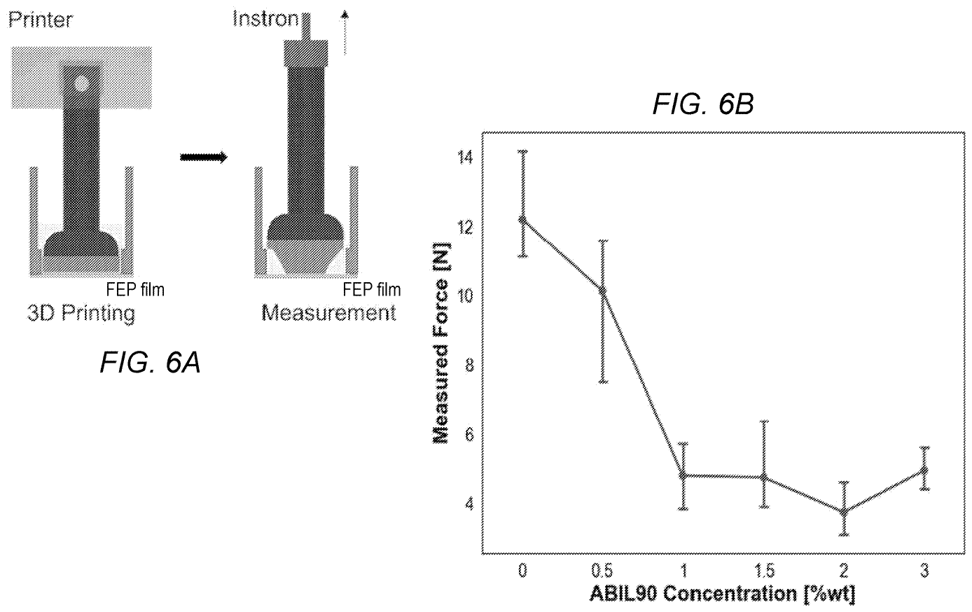

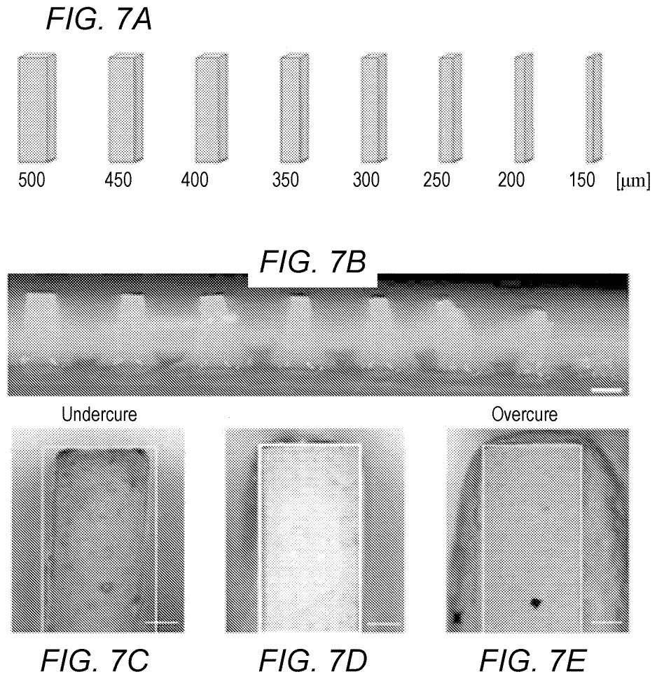

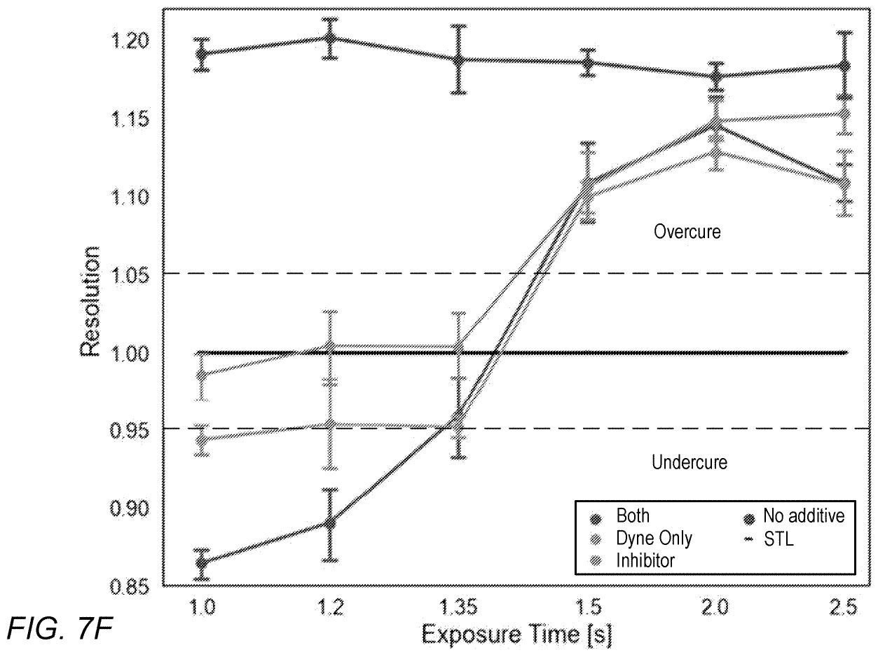

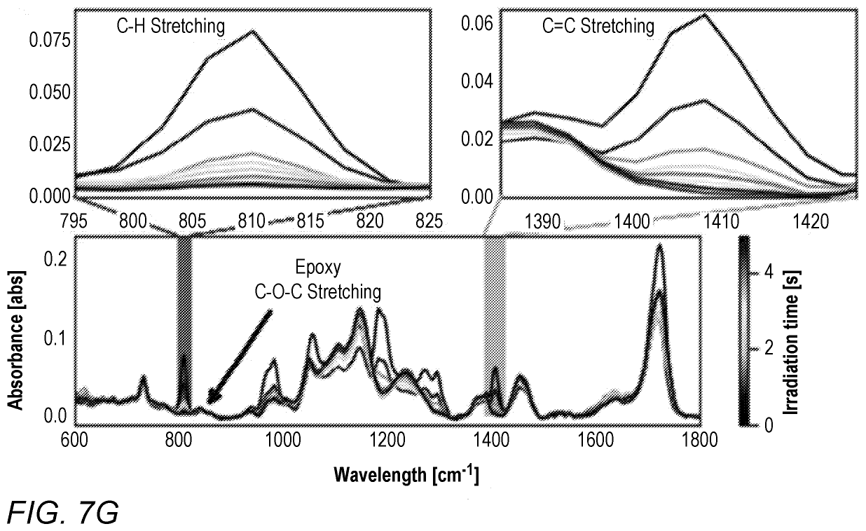

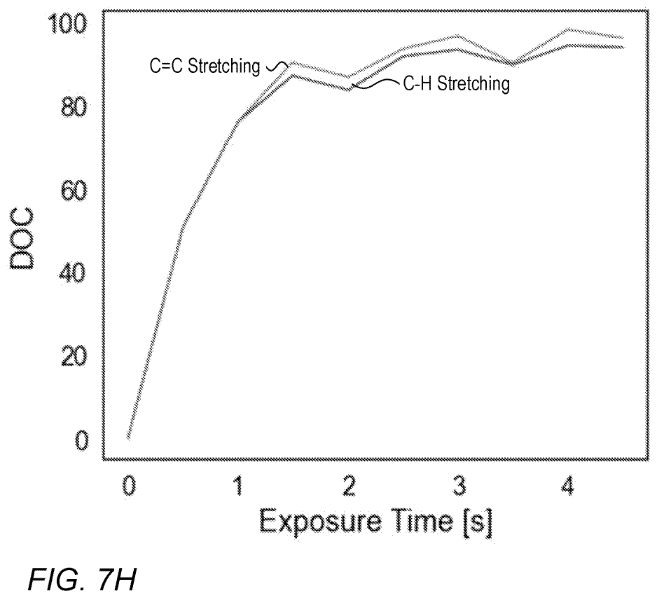

When the first layer of the emulsion ink is polymerized on the printing platform, it was observed that the adhesion of the layer fails due to the presence of water droplets, thus causing the built structures to fall from the platform. This problem was solved by first printing a 300 μm layer of PUA only, thus providing a layer that could adhere better to the continuous phase of the emulsion since both are composed of the same polymer. A second problem encountered was that the emulsion adhered to the vat window after printing. This is a common problem, which until now was addressed by several approaches, such as modifying the surfaces to reduce their surface energy by using special membranes in Continuous Liquid Interface Production(CLIP) or by using hydrogel surfaces. Although these methods can be successful, they require overly complicated and precise preparation processes. The innovative approach disclosed herein is based on the reduction of the surface tension of the printing ink itself, simply by adding a silicone-based surfactant (modified polyether-polysiloxane, ABIL 90) to the ink. A quantitative evaluation of the adhesion force of the polymerized emulsion to the FEB film, in presence of the surfactant, was performed by measuring the force required to detach the polymerized layer from the FEB surface. The measurements were performed by a self-design setup that simulates the process of a single layer printing with the exact conditions of the 3D printer and with the same FEB film (schematically shown in FIG. 6A). For this, the downward movement of the platform and layer formation is performed within the 3D printer, and the upward movement was done by the force measurement instrument (Instron 3345). The force required to detach the polymerized layer from the film, as a function of surfactant concentration, is presented in FIG. 7B. As seen, the force decreases from 12 N to 4 N, with the increase of surfactant concentration from 0 to 1 wt %, and remains about the same at higher surfactant concentrations. By printing experiments, it was found that 4N was sufficient to enable layer detachment while printing. Overall, there were no film adhesion issues at surfactant concentrations above 1%.

In general, DLP printing of dispersed systems is challenging due to light scattering from the dispersed phase, which causes polymerization in undesired areas, and results in printed objects with low resolution. To improve the resolution, control over the localized polymerization was addressed by two approaches; inhibition of the photo-polymerization by radical scavenging, using hydroquinone (HyQ), and preventing unwanted photoinitiator activity by adding a UV absorber, Sulforhodamin B (SolB) which competes with the photoinitiators.

Four formulations were prepared to test the validity of the approach, one without HyQ and SolB, the second containing both, and two containing each separately. The printing performance of the formulations was evaluated for 3D printed pillars having different widths, starting from the minimal printer pixel size of 62 μm, up to 500 μm as shown in FIG. 7A-B. It was observed that below the width of 300 μm, the material was not mechanically stable, resulting in torn (below 150 μm) or crooked (200-300 μm) pillars. Therefore, the pillars with a width of 350 μm were selected for evaluating the resolution, in which we defined ±0.5 deviation as the threshold for good resolution.

In FIGS. 7C-E the dimensions of the 350 μm pillar are compared with the dimensions in the original STL file (marked in white frame) by measuring the actual width at different exposure times. For low exposure times (<1.2 sec), the measured size is smaller than the projected STL file resulting in an under-cured pillar (FIG. 7C), meaning that the polymerization was not complete. On the contrary, when irradiating too much (>1.5 sec), the pillar actual size is significantly larger than the projected STL file (FIG. 7E), meaning that the pillar was polymerized too much and overcuring occurs. FIG. 7F shows more specifically the resolution as a function of the exposure time of the four above-mentioned emulsions (with and without additives). For the formulation without any additives, the printed pillars overcured with poor resolution of 1.2, independent of the exposure time. This poor resolution was dramatically improved with the formulations containing HyQ and SolB, enabling high-resolution prints and pinpointing the exposure time to the range of 1.2 to 1.4 seconds.

This finding was supported by evaluation of the double bond conversion (DOC) as a function of the exposure time, by following both the acrylate C—H and C═C stretching peaks at 808 cm⁻¹ and 1407 cm⁻¹, shown in the green and yellow areas in FIG. 5G respectively, relative to the constant C—O—C peak at 852 cm⁻¹. The conversion calculation was described in section 3.8.

It was found (FIG. 7H) that at an exposure time of 1.35 sec and above, up to 90% conversion is achieved, which is typically considered to be fully polymerized for free radical polymerization.

### Demonstration and Literature Review

After establishing the material's compositions and the major factors affecting its printability, an object with a complex structure was 3D printed to demonstrate the material capabilities. As presented in FIG. 2, the object is constructed from a unit cell of a Buckyball-type structure with 6 hexagons and 4 squares that are arranged in a 4X 2 array. The structure was very stretchable and could be easily deformed by twisting, compressing, and stretching, with a rapid and full recovery of the structure.

The printed foams were compared with the literature reports for foams that were 3D printed by various technologies (FIG. 2C). It should be noted that known products produced by photopolymerization-based printing of foams/porous materials result in stiff polymers or ceramics that cannot elongate and therefore tensile measurements were not reported for. As shown in FIG. 2C, most porous objects were fabricated by materials that are not UV-curable, thus limiting their fabrication methods to low-resolution extrusion-based 3D printing (DIW, FDM) or powder-based printing (Binder jetting (BJ) and Selective laser melting (SLM)). To the best of the inventors'knowledge, the approach presents the first stereolithography-based 3D-printed stretchable porous objects, having such high value of elongation at break.

It should be noted that although the above examples were given for objects printed by DLP, any other irradiation-based 3D printing is suitable, for example Volumertic Printing, CLIP printing, Polyjet etc. Moreover, printing by Direct Ink Write process (extrusion based) is also possible, while using light irradiation upon the extrusion. Therefore, in view of the available technologies, 3D foam printing can lead to small, mm size objects, up to meters scale objects.

1-65. (canceled)

66. A stretchable 3D printed polymeric foam having hyperplastic properties, the foam comprising at least one elastomer and having a predetermined multiscale porosity comprising predesigned macrometric cells connected by porous walls having a random micrometric pore structure, and wherein the macrometric cells are 2 to 50 mm in size and wherein the micrometric pore structure comprising a plurality if pores having a size ranging from 50 nm and 10 μm.

67. The foam according to claim 66, wherein the micrometric pore structure comprising a plurality of pores having a size ranging between 1 and 10 μm.

68. The foam according to claim 66, wherein the micrometric pore structure comprising a plurality of pores having an average size of about 3 μm.

69. The foam according to claim 66, in a hydrated form, wherein the micrometric pore structures comprising a plurality of pores containing water or a medium comprising water.

70. The foam according to claim 66, formed of polyurethane acrylate.

71. The foam according to claim 66, having a 2D honeycomb-like structure; a 3D structure with an open cell configuration wherein the pores are connected by struts or supports or walls; a 3D structure with a closed cell configuration wherein the pores are fully enclosed within pore walls, or mixed forms wherein both open and closed cells are present.

72. A process for forming a foam or a porous object, the process comprising light curing a resin in a form of a water-in-oil (W/O) emulsion comprising at least one light-curable material to obtain a predesigned 3D porous structure comprising interconnected cells of a size between 2 and 50 mm, wherein walls interconnecting the cells comprise micrometric pores having random sizes ranging between 50 nm and 10 μm and pore distribution.

73. The process according to claim 72, wherein at least a portion or all of the micrometric pores are formed as volatile water or liquid droplets or pockets.

74. The process according to claim 72, the process comprising
light curing a resin in a form of a W/O emulsion comprising at least one light-curable material and at least one photoinitiator to obtain a 3D structure having a predesigned/predetermined cell structure comprising a plurality of cells interconnected through walls defining same, said walls comprising randomly distributed and randomly sized plurality of water-filled pockets; and
optionally causing said water-filled pockets to empty to provide a dry or water-free foam.

75. The process according to claim 72, for manufacturing a dry, or dehydrated or water-free porous polymeric structure or foam, the process comprising:
light curing a resin in a form of a W/O emulsion comprising at least one light-curable material and at least one photoinitiator to obtain a 3D structure having a predesigned/predetermined cell structure comprising a plurality of cells interconnected through walls defining same, said walls comprising randomly distributed and randomly sized plurality of water-filled pockets; and
causing said water-filled pockets to empty to provide the dry or water-free porous polymeric structure of foam.

76. A process according to claim 72, for manufacturing a dry or dehydrated or water-free foam or a porous polymeric object having a multiscale porosity defined by predesigned macrometric cells and random micrometric pore structures, the process comprising
3D printing and light curing a water-in-oil (W/O) emulsion comprising a water phase and an oil phase comprising at least one light-curable material and a photoinitiator, to obtain a polymeric structure having the predesigned macrometric cells; and
treating said polymeric structure to remove water contained within micrometric pores formed in said polymeric structure, to form the random micrometric pore structures in walls interconnecting the macrometric cells.

77. The process according to claim 72, wherein said printing is a 3D printing selected from Digital Light Processing (DLP), stereolithography (SLA), Direct Ink Write (with light irradiation), Polyjet printing, Volumetric Printing, Two Photons Polymerization printing and extrusion deposition.

78. The process according to claim 77, wherein the 3D printing is DLP.

79. The process according to claim 72, wherein the W/O emulsion is a W/O nanoemulsion or a W/O microemulsion, wherein water is a dispersed phase and the light-curable material is a continuous phase.

80. The process according to claim 72, wherein the light-curable material is a light-sensitive water-insoluble material capable of undergoing curing under UV, NIR or visible light, in presence of a photoinitiator; or wherein the light-curable material is one or a mixture of two or more materials capable of undergoing one or more chemical reactions to form stable covalent bonds; or wherein the light-curable material is a monomer, oligomer, prepolymer or a polymer unit of the polymeric material forming the object or foam; or wherein the light-curable material is selected amongst acrylates, methacrylates, styrenic compounds, vinyl ethers, aromatic compounds having vinyl groups, epoxides, urethanes, lactones, thiolenes, lactams, cyclic ethers, cyclic acetals, cyclic siloxanes, polyethers, polyesters, maleimides and allyl compounds; or wherein the light-curable material is selected from urethane acrylates and acryl polydimethyl siloxane; or wherein the light-curable material is a UV-curable material; or wherein the light-curable material is urethane acrylate.

81. The process according to claim 72, wherein the W/O emulsion comprises an amount of water not causing phase inversion to an oil-in-water emulsion; or wherein the emulsion comprises an amount of water that does not exceed or is not greater than 70 wt %; or wherein the emulsion comprises an amount of water that is not greater than 55 wt %; or wherein the emulsion comprises an amount of water that is not greater than 45 wt %; or wherein the emulsion comprises an amount of water that is between 4 wt % and 35 wt %; or wherein the emulsion comprises between 35 wt % and 90 wt % of the light-curable material; or wherein the emulsion comprises a hyperplastic material.

82. The process according to claim 81, wherein the hyperplastic material is selected from elastomers, thermoplastic elastomers, thermoplastic polyamide elastomers, thermoplastic copolyester elastomers, olefin-based thermoplastic elastomers, thermoplastic styrene block copolymers, urethane thermoplastic elastomers, olefin-based thermoplastic vulcanizates, crosslinked olefin-based thermoplastic elastomers, vulcanizates of natural rubbers, vulcanizates of synthetic rubbers, styrene-butadiene rubber, butadiene rubber (BR), acrylonitrile-butadiene rubber (NBR), butyl rubber (IIR), ethylene-propylene-diene rubber (EPDM), chloroprene rubber (CR), polyisoprene rubber (IR), polyalkylsiloxanes, polydimethylsiloxane, silicone rubbers, silicone elastomers, methyl silicone, vinyl-methyl-silicone, phenyl-vinyl-methyl-silicone, phenyl-modified silicone, fluoroalkyl-silicone, and fluoro-vinyl-methyl-silicone.

83. A foam formed by a process according to claim 72.

84. A 3D printed foam comprising or consisting or consisting essentially polyurethane acrylate, the foam having a multiscale porosity comprising predesigned macrometric cells connected by porous walls having a random micrometric pore structure, wherein the macrometric cells having a size ranging between 2 mm and 50 mm and wherein the micrometric pore structure comprising a plurality of pores having a size ranging between 5 nm and 50 μm.

85. The foam according to claim 84, manufactured by light curing of a water-in-oil resin comprising at least one light-curable material.
